(19) United States
(12) Patent Application Publication
(10) Pub. No.: US 2020/0361400 A1
(43) Pub. Date: Nov. 19, 2020

(54) ANCHOR CLIP

(71) Applicant: Calsonic Kansei North America, Inc., Farmington Hills, MI (US)

(72) Inventor: Mauricio A. Loyola, Farmington Hills, MI (US)

(21) Appl. No.: 16/415,648

(22) Filed: May 17, 2019

(51) Int. Cl. B60R 13/02; F16B 2/24

(52) U.S. Cl. CPC B60R 13/02; F16B 2/24

(57) ABSTRACT

Disclosed is an anchor clip assembly configured to couple a panel to a base. The anchor clip assembly includes a fixing clip formed on the panel and engaged with an aperture in the base. The assembly also includes an anchor clip formed on the panel and slidably engaged with an elongated hole in the base. The fixing clip is configured to disengage from the aperture without disengaging the anchor clip from the elongated hole.

### BACKGROUND

The present disclosure relates generally to an anchor clip structure. More specifically, the present disclosure relates to an anchor clip structure used to secure a trim panel to a vehicle.

Existing vehicle interiors include dashboard instrument clusters, window controls, and other electronic components to facilitate vehicle operations. Trim panels may be mounted to different areas within the vehicle interior to cover these components and other areas of the vehicle. The trim panels prevent an occupant from tampering with sensitive electronic components and improve the overall aesthetic of the vehicle interior.

The trim panels may be secured to the vehicle interior using clips. The clips allow the trim panels to be removed during maintenance events to access underlying components. However, these clips are susceptible to impact loads and may not provide sufficient holding force to support the trim panel during a vehicle collision. Manufacturers generally utilize secondary clips or retainers as a fail-safe to prevent the trim panel from fully separating from the vehicle during a vehicle collision, but such secondary clips or retainers tend to be relatively large and may be difficult to integrate on the trim panel. Additionally, these secondary clips can be difficult to disengage when attempting to remove the trim panel during maintenance events.

It would be advantageous to provide an improved anchor clip that addresses the aforementioned issues. These and other advantages will be apparent to those reviewing the present disclosure.

### SUMMARY

At least one embodiment relates to an anchor clip assembly. The anchor clip assembly includes a base and a panel. The panel is engaged with the base. The panel includes a fixing clip and an anchor clip. Both the fixing clip and the anchor clip are formed on the panel. The fixing clip is engaged with an aperture in the base. The anchor clip is slidably engaged with an elongated hole in the base. The fixing clip is configured to disengage from the aperture without disengaging the anchor clip from the elongated hole.

Another embodiment is a method of detaching a panel from a base. The panel includes a fixing clip and an anchor clip. The base includes an aperture and an elongated hole. The elongated hole includes a narrow portion and a wide portion. The fixing clip is engaged with the aperture and the anchor clip is engaged with the elongated hole. The method includes disengaging the fixing clip from the aperture. The method also includes sliding the anchor clip along a longitudinal direction of the elongated hole. The method further includes positioning the anchor clip at the wide portion of the elongated hole and pulling the anchor clip through the wide portion of the elongated hole.

Another embodiment is a panel. The panel includes a fixing clip and an anchor clip. Both the fixing clip and the anchor clip are formed on the panel. The fixing clip is configured to engage with an aperture in a base. The anchor clip is configured to be slidably engaged with an elongated hole in the base. A height of the anchor clip is greater than a height of the fixing clip.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of an anchor clip assembly, according to an exemplary embodiment.

FIG. 2 is an exploded view of the anchor clip assembly of FIG. 1, according to an exemplary embodiment.

FIG. 3 is a side view of a panel of the anchor clip assembly of FIG. 1, according to an exemplary embodiment.

FIG. 4 is a front sectional view of the panel of FIG. 2, according to an exemplary embodiment.

FIG. 5 is a top view of the panel of FIG. 2, according to an exemplary embodiment.

FIG. 6 is a top view of a base of the anchor clip assembly of FIG. 1, according to an exemplary embodiment.

FIG. 7 is a schematic diagram illustrating a method of detaching a panel from a base, according to an exemplary embodiment.

FIG. 8 is a side view of the anchor clip assembly of FIG. 1, according to an exemplary embodiment.

FIG. 9 is a side view of the anchor clip assembly of FIG. 1 with a fixing clip partially disengaged from the base, according to an exemplary embodiment.

FIG. 10 is a top view of the anchor clip assembly of FIG. 1 with a fixing clip partially disengaged from the base, according to an exemplary embodiment.

FIG. 11 is a top view of the anchor clip assembly of FIG. 1 with an anchor clip positioned in a wide portion of an elongated hole in the base, according to an exemplary embodiment.

FIG. 12 is a side view of the anchor clip assembly of FIG. 1 with an anchor clip positioned in a wide portion of an elongated hole in the base, according to an exemplary embodiment.

FIG. 13 is a side view of the anchor clip assembly of FIG. 1 with a panel separated from a base, according to an exemplary embodiment.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the Figures, an anchor clip assembly (e.g., structure, etc.) is configured to secure a trim panel or finishing piece to a vehicle. For example, the anchor clip assembly may be configured to mount a finishing piece to an instrument panel or other structure within a cab of the vehicle. The anchor clip assembly includes a panel, which in various exemplary embodiments forms part of the trim panel or finishing piece, and a base, which in various exemplary embodiments forms part of the vehicle (e.g., instrument panel, body panel, etc.) to which the trim panel is mounted.

The panel includes a fixing clip and an anchor clip. The anchor clip is configured to prevent the panel from breaking free (e.g., separating, detaching, etc.) from the base during a collision or in the event that the fixing clip at least partially disengages from the base. The base includes an aperture (e.g., a hole) and an elongated hole. The elongated hole includes a narrow portion and a wide portion. The fixing clip is configured to engage with the aperture in the base. The anchor clip is configured to slidably engage with the elongated hole in the base so that it may move between the narrow portion and the wide portion. According to an exemplary embodiment, the anchor clip is engaged with the narrow portion when the fixing clip is engaged with the aperture, which, advantageously, prevents the anchor clip from disengaging from the elongated hole during a vehicle collision.

The panel is configured to detachably couple to the base so that a user or technician may access components hidden beneath the trim panel during maintenance events. To disengage the panel from the base, a user at least partially disengages the fixing clip from the aperture. The user slides the base in a longitudinal direction to reposition the anchor clip within the wide portion of the elongated hole from which the anchor clip may be drawn through the elongated hole unimpeded. These and other advantageous features will become apparent to those review the present disclosure and figures.

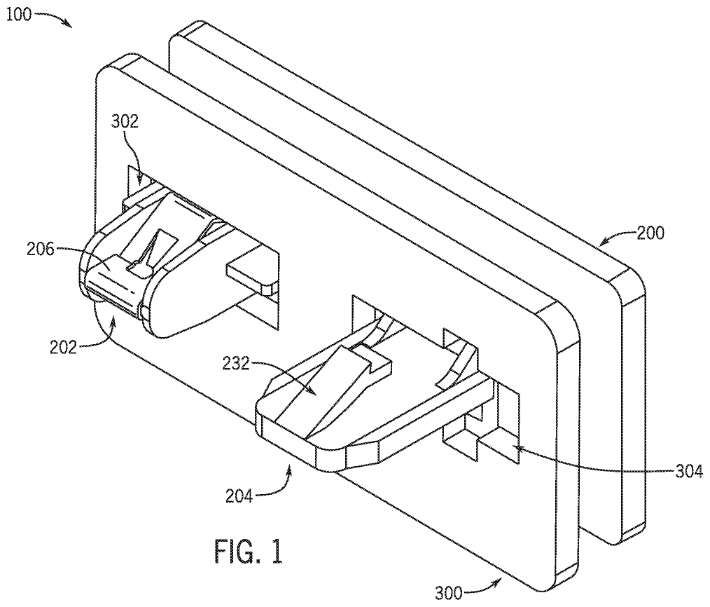

Referring now to FIG. 1, an anchor clip assembly 100 is shown, according to an exemplary embodiment. The anchor clip assembly 100 includes a panel 200 and a base 300. The panel 200 is detachably coupled to the base 300. The panel 200 may be one of a variety of different trim panels or finishing pieces for a vehicle. For example, the panel 200 may form part of a finishing piece of an instrument panel in a cab of the vehicle. In other embodiments, the panel 200 may form part of a trim panel of a door or another part of the cab. The vehicle may be a car, truck, an off-road utility vehicle, or the like.

The base 300 may be any one of a variety of vehicle components configured to engage with and support the weight of the panel 200. For example, the base 300 may be one of a door or body panel surrounding electrical components (e.g., an electric motor for a window, a speaker, etc.) within a door. In another example, the base 300 may be an instrument panel that supports an audio unit, part of the instrument cluster, or another type of vehicle accessory. The panel 200 is configured to couple to the base 300. The panel 200 may be configured to cover seams between body panels and/or other vehicle components such as the electronic components to prevent damage and improve the overall appearance of the vehicle's interior.

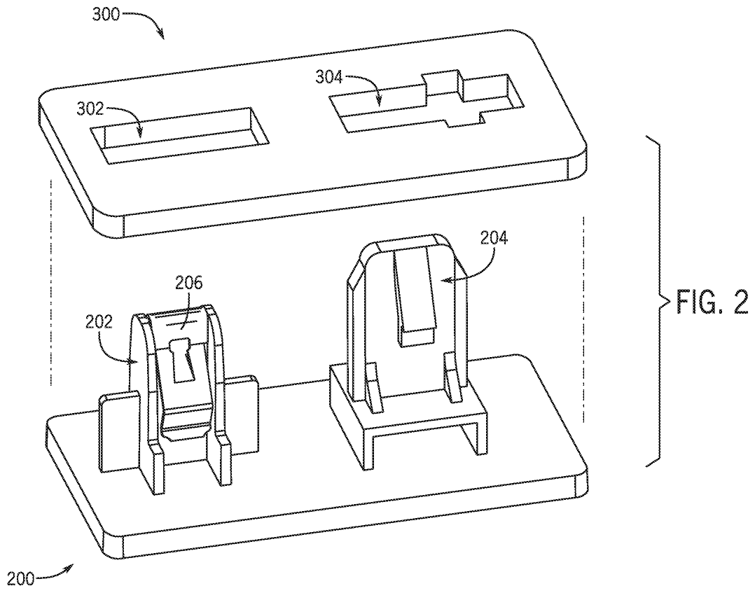

As shown in FIGS. 1-2, the panel 200 is configured to engage with the base 300 in at least two locations. The panel 200 includes a fixing clip 202 configured to engage with an aperture 302 in the base 300. The panel 200 also includes an anchor clip 204 configured to slidably engage with an elongated hole 304 in the base 300. As shown in FIG. 1, the fixing clip 202 is detachably (e.g., removably, etc.) coupled to the aperture 302 and supported at least partially along a perimeter of the aperture 302 via a metal clip 206. In this way, the fixing clip 202 prevents movement of the panel 200 relative to the base 300. As shown in FIG. 1, the weight of the panel 200 is entirely supported by the fixing clip 202 when the fixing clip is engaged with the aperture 302.

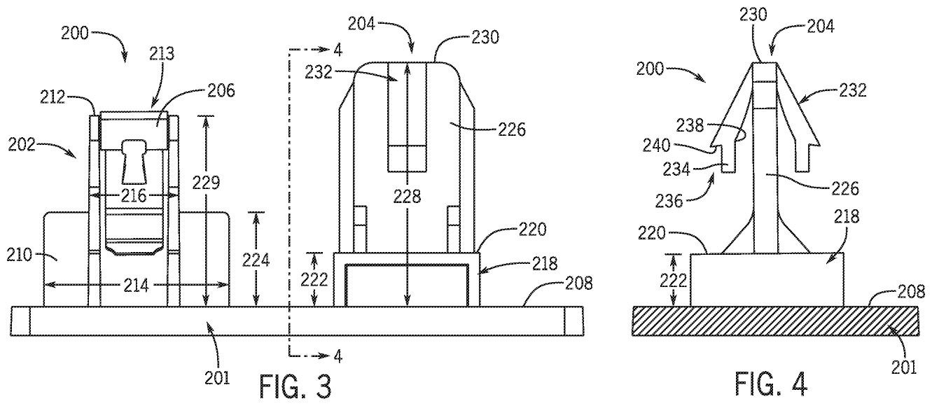

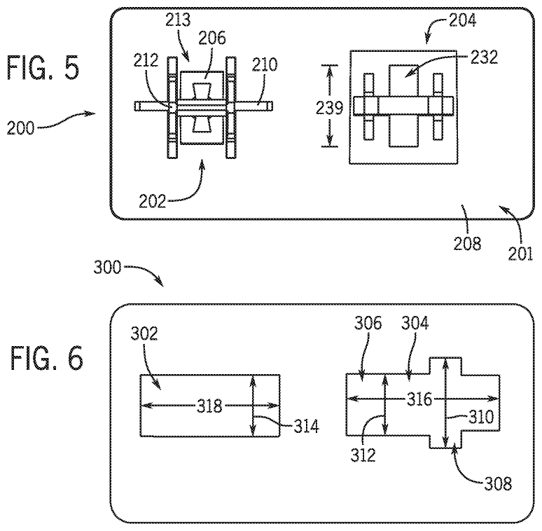

According to an exemplary embodiment, the anchor clip assembly 100 is configured to provide a blind connection between the panel 200 and the base 300. As shown in FIGS. 3-5, the panel 200 includes a body 201, a single fixing clip 202, and a single anchor clip 204. In other embodiments, the panel 200 may include a plurality of fixing clips 202 and a single anchor clip 204. Among other benefits, using a single anchor clip 204 reduces part complexity. In yet other embodiments, additional anchor clips 204 may be used. As shown in FIGS. 3 and 5, both the fixing clip 202 and the anchor clip 204 are at least partially integrally formed (e.g., molded, cast, or otherwise formed) with the panel 200 as a single unitary structure. Accordingly, at least a portion of the fixing clip 202 and the anchor clip 204 are made from the same material as the body 201. In other embodiments, the fixing clip 202 and/or the anchor clip 204 may be formed as a separate piece(s) from the body 201 and welded, fastened, or otherwise coupled to the body 201. As show in FIG. 3, the fixing clip 202 and the anchor clip 204 are coupled to a first surface 208 of the body 201 and extend upwardly in substantially perpendicular orientation relative to the body 201 (e.g., the first surface 208).

As shown in FIGS. 3 and 5, the fixing clip 202 and the anchor clip 204 are arranged in substantially parallel orientation with respect to one another. The fixing clip 202 includes a substantially rectangular lower portion 210 extending from the first surface 208 and an upper portion 212 coupled thereto (e.g., extending from an upper edge of the lower portion 210). As shown in FIG. 3, a length 214 of the lower portion 210 in a substantially longitudinal direction (e.g., left-to-right as shown in FIG. 3) is greater than a length 216 of the upper portion 212. According to the exemplary embodiment of FIG. 1, the length 214 of the lower portion 210 is approximately the same as a length of the aperture 302 in the base 300, such that the lower portion 210 engages with a perimeter of the aperture 302 when the panel 200 is fully coupled to the base 300. Among other benefits, the lower portion 210 prevents the panel 200 from sliding in a longitudinal direction relative to the base 300 when the fixing clip 202 is fully engaged with the aperture 302. Moreover, the lower portion 210 maintains a position of the anchor clip 204 along the elongated hole 304, within a narrow portion 306 of the elongated hole 304, when the panel 200 is fully engaged with the base 300.

According to an exemplary embodiment, at least a portion of the fixing clip 202 is made from the same material as the panel 200. As shown in FIGS. 3 and 5, the fixing clip 202 includes a metal clip 206 coupled to a tower 213, which is defined by a combination of the upper portion 212 and the lower portion 210 of the fixing clip 202. The metal clip 206 may be a spring trim panel retainer or another type of trim or panel retaining clip. The upper portion 212 is “sandwiched” or otherwise disposed between opposing arms of the metal clip 206. As shown in FIG. 5, the upper portion 212 includes two substantially parallel extensions on opposing sides of the upper portion 212 defining an “H” shaped channel, which, advantageously, prevents movement of the metal clip 206 in the longitudinal direction along the upper portion 212. In other embodiments, the extensions may be arranged differently. For example, the extensions may extend beyond only one side of the upper portion 212 to define a “U” shaped channel. The length of the extensions may also be different in various exemplary embodiments.

As shown in FIG. 4, the anchor clip 204 includes a platform 218 extending upwardly from the first surface 208 of the body 201. The platform 218 is formed as a generally rectangular extrusion defining a hollow portion therein. The platform 218 defines a generally planar upper surface 220 in substantially parallel orientation with the first surface 208 of the body 201. A height 222 of the platform 218, between the upper surface 220 and the first surface 208, sets a separation distance between the body 201 and the base 300 when the panel 200 is fully engaged with the base 300. As shown in FIG. 3, the height 222 of the platform 218 is less than a height 224 of the lower portion 210 of the fixing clip 202. The difference in height ensures that the lower portion 210 will contact the perimeter of the aperture 302 when the fixing clip 202 is fully engaged with the aperture 302 (see also FIG. 1).

As shown in FIGS. 3-4, the anchor clip 204 includes a tab 226 extending from the upper surface 220 of the platform 218 in a substantially perpendicular orientation with the upper surface 220. As shown in FIG. 3, a height 228 of the anchor clip 204, from an upper edge 230 of the tab 226 to the first surface 208, is greater than a height 229 of the tower 213. Among other benefits, this difference in height ensures that an angled portion 232 of the anchor clip 204 remains separated (e.g., spaced apart) from the base 300 when the fixing clip 202 is fully engaged with the aperture 302 (see also FIG. 1). This spacing reduces the risk of damage to the anchor clip 204 during a vehicle collision (e.g., head impact, airbag deployment, or other impact to the panel 200), in which a majority of the force will be transmitted to the fixing clip 202 rather than the anchor clip 204.

As shown in FIG. 1, the anchor clip 204 is configured to slidably engage with the elongated hole 304 in the base 300. As shown in FIG. 4, the anchor clip 204 includes a plurality of angled portions 232 extending at least partially downwardly from the upper edge 230 of the anchor clip 204 (e.g. tab 226). The angled portions 232 are configured to deform inwardly (e.g., toward the tab 226) when pressed into the narrow portion 306 of the elongated hole 304. As shown in FIG. 1, the angled portions 232 expand outwardly (e.g., away from the tab 226) once pushed through the elongated hole 304 so as to retain the anchor clip 204 within the elongated hole 304. In this way, the anchor clip 204 functions similarly to the fixing clip 202 when initially engaging the panel 200 with the base 300. Among other benefits, no additional alignment or manual manipulation of the panel 200 (e.g., beyond what is required to fully engage the fixing clip 202) is required to engage the anchor clip 204 with the base 300. According to an exemplary embodiment, the angled portions 232 are integrally formed with the tab 226 as a single unitary structure. It will be appreciated that a variety of different deformable geometries may be molded onto the tab 226 without departing from the inventive concepts disclosed herein.

As shown in FIG. 4, each of the angled portions 232 includes a leg 234 that extends substantially downwardly from a free end 236 of the angled portion 232 in substantially parallel orientation with the tab 226 of the anchor clip 204. According to an exemplary embodiment, the leg 234 is disposed on an inside edge 238 of the free end 236 such that an inner surface of the leg 234 extends directly from the inside edge 238. Together, the leg 234 and the free end 236 define a generally “L” shaped step 240 facing away from the tab 226. According to an exemplary embodiment, the step 240 is configured to engage with the narrow portion 306 of the elongated hole 304. Among other benefits, the legs 234 and step 240 prevent rotation of the panel 200 when the fixing clip 202 is at least partially disengaged from the aperture 302.

Referring now to FIG. 6, the base 300 is shown, according to an exemplary embodiment. The aperture 302 in the base 300 includes a rectangular slot (e.g., hole, opening, etc.) that extends through the base 300. The elongated hole 304 is arranged in-line with the aperture 302. In other embodiments, the arrangement of the aperture 302 and/or hole 304 along the base 300 may be different. As shown in FIG. 6, a cross-section through the elongated hole 304 is substantially “t” shaped (e.g., cross shaped) when viewed normal to the base 300. The elongated hole 304 includes a narrow portion 306 and a wide portion 308. As shown in FIG. 6, the wide portion 308 extends over an intermediate portion of the elongated hole 304. In other embodiments, the wide portion 308 extends from an intermediate portion to an end of the elongated hole 304. According to an exemplary embodiment, a width 310 of the wide portion 308 in a lateral direction (e.g., vertically up and down as shown in FIG. 6) is greater than a maximum width 239 of the anchor clip 204 (see also FIG. 5). In other words, the wide portion 308 is sized to receive the anchor clip 204 therein without any interference.

The aperture 302 and the elongated hole 304 are sized to facilitate manual manipulation of the panel 200 and the base 300. As shown in FIG. 6, a width 312 of the narrow portion 306 is approximately equal to a width 314 of the aperture 302. A length 316 of the elongated hole 304 in a longitudinal direction (e.g., left-to-right as shown in FIG. 6), in which the panel 200 is configured to slide relative to the base 300, is greater than a length 318 of the aperture 302. According to an exemplary embodiment, a length of the wide portion 308 of the elongated hole 304 is slightly greater than a length of the angled portion 232 of the anchor clip 204 so that that the angled portion 232 may pass through the wide portion 308 freely and without interference.

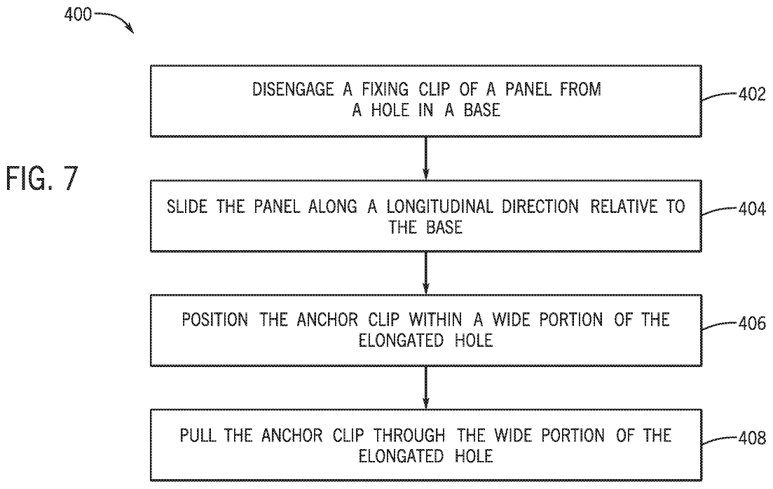

Referring now to FIGS. 7-13, a method 400 of detaching (e.g., disengaging, decoupling, separating, etc.) the panel 200 from the base 300 is shown, according to an exemplary embodiment. The operations described herein may be performed, for example, by a technician during a maintenance event, in order to access electronic components or areas of a vehicle covered by a trim panel or finishing piece.

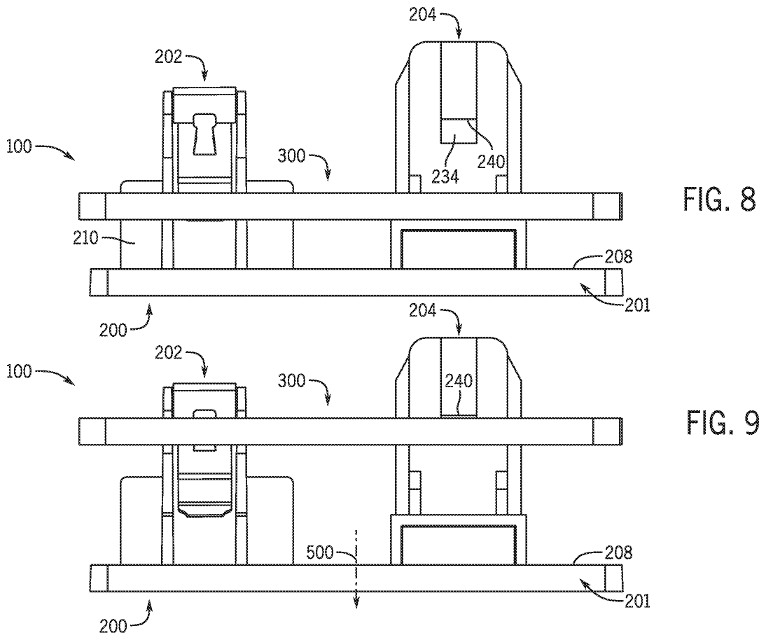

In operation 402, a fixing clip of the panel is disengaged from a hole in a base. The panel and base may be the same or similar to the panel 200 and base 300, respectively, described with reference to FIGS. 1-6. By way of example, the panel 200 is shown to be fully engaged with the base 300 in FIG. 8. As shown in FIG. 8, the fixing clip 202 is engaged with the aperture 302. The lower portion 210 of the fixing clip 202 prevents longitudinal movement (e.g., left-to-right as shown in FIG. 8) of the panel 200 relative to the base 300. The anchor clip 204 is slidably engaged with the narrow portion 306 of the elongated hole 304 but is fixed in position relative to the base 300 by the fixing clip 202.

As shown in FIGS. 8-9, the panel 200 is pulled away from the base 300 in a direction normal to the body 201 (e.g., normal to the first surface 208 of the body 201) as indicated by the dashed arrow 500. The fixing clip 202 is pulled through the aperture 302 to disengaging the metal clip 206 from an outer perimeter of the aperture 302. Movement of the panel 200 relative to the base 300 continues until the step 240 fully engages with the narrow portion 306 of the elongated hole 304. In this position, the panel 200 is free to move in a longitudinal direction in which the anchor clip 204 slides along the elongated hole 304.

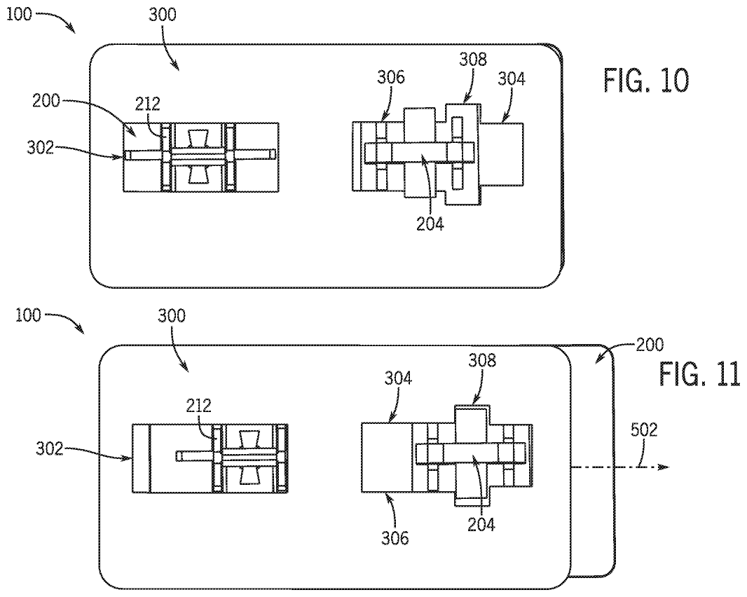

In operation 404, the panel 200 is slid along a longitudinal direction relative to the base 300. FIG. 10 shows a top view of the anchor clip assembly 100 of FIG. 9, after disengaging the fixing clip 202 from the base 300. FIG. 11 shows the position of the panel 200 relative to the base 300 toward the end of operation 404. The movement of the panel 200 relative to the base 300, as indicated by the dashed arrow 502 in FIG. 11, shifts the anchor clip 204 from the narrow portion 306 toward the wide portion 308 of the elongated hole 304. During operation 404, the upper portion 212 remains engaged (e.g., slidably engaged) with the aperture 302. Together, the upper portion 212 and the legs 234 of the anchor clip 204 prevent rotation of the panel 200 relative to the base 300 (see also FIG. 4).

In operation 406, the anchor clip 204 is repositioned to be substantially within the wide portion 308 of the elongated hole 304. In other words, the anchor clip 204 is repositioned to substantially center the angled portion 232 within the wide portion 308 of the elongated hole 304. According to an exemplary embodiment, the wide portion 308 is positioned and sized such to align the angled portion 232 by engaging the anchor clip 204 (e.g., tab 226) with a perimeter of the elongated hole 304 (e.g., a rightmost edge of the elongated hole 304 as shown in FIG. 11). Among other benefits, this configuration reduces the amount of manual manipulation required to achieve alignment between the angled portion 232 and the wide portion 308.

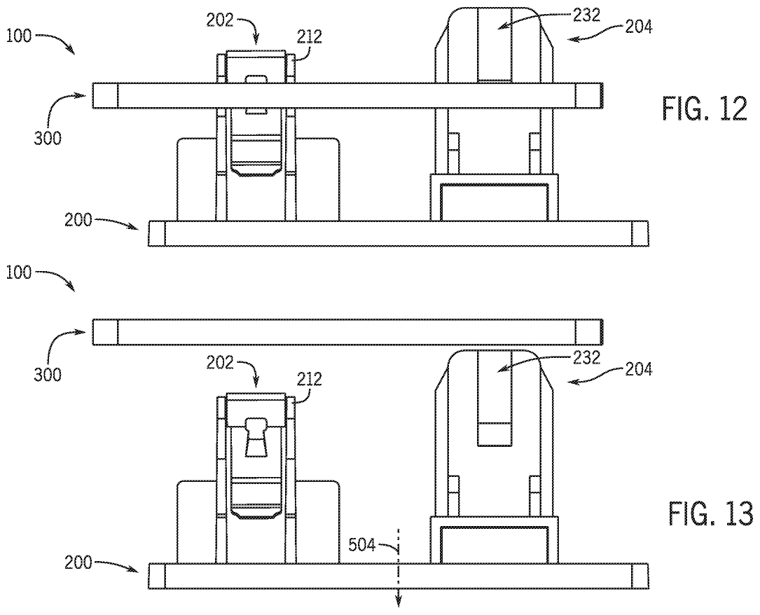

In operation 408, the anchor clip 204 is pulled through the wide portion 308 of the elongated hole 304. As shown in FIGS. 12-13, a substantially normal force is applied to the panel 200 in order to draw the angled portion 232 out through the wide portion 308 and fully disengage the panel 200 from the base 300. The direction of movement of the panel 200 relative to the base 300 is indicated by a dashed arrow 504 in FIG. 13. During operation 408, the upper portion 212 of the fixing clip 202 is also disengaged from the aperture 302.

The anchor clip assembly, of which various exemplary embodiments are disclosed herein, provides several advantages over existing trim panel fail-safe retainers. The anchor clip assembly includes a panel including a fixing clip and an anchor clip. The anchor clip is configured to maintain a connection between the panel and a base during a vehicle collision (e.g., a head impact, etc.) or when the fixing clip becomes damaged or decoupled from the base. The panel may be separated from the base manually by sliding the panel relative to the base once the fixing clip is at least partially disengaged. Additionally, the anchor clip occupies nearly the same volume as the fixing clip, which allows the anchor clip structure to be utilized in a larger variety of applications when compared to traditional fail-safe retainers.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other illustrative embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various illustrative embodiments without departing from the scope of the present invention.

What is claimed is:

1. An anchor clip assembly, comprising:
a base;
a panel engaged with the base;
a fixing clip formed on the panel and engaged with an aperture in the base; and
an anchor clip formed on the panel and slidably engaged with an elongated hole in the base, wherein the fixing clip is configured to disengage from the aperture without disengaging the anchor clip from the elongated hole.

2. The anchor clip assembly of claim 1, wherein the elongated hole comprises a wide portion and a narrow portion, wherein a width of the wide portion is greater than a maximum width of the anchor clip, and wherein the anchor clip is engaged with the narrow portion when the fixing clip is engaged with the aperture.

3. The anchor clip assembly of claim 1, wherein the panel comprises a plurality of fixing clips, and wherein a single anchor clip is formed on the panel.

4. The anchor clip assembly of claim 1, wherein the fixing clip comprises a metal clip, wherein the anchor clip is integrally formed with the panel, and wherein the anchor clip is made from the same material as the panel.

5. The anchor clip assembly of claim 1, wherein the anchor clip comprises a plurality of angled portions, wherein each one of the angled portions includes a leg disposed on an inside edge of a free end of the angled portion.

6. The anchor clip assembly of claim 1, wherein a cross-section through the elongated hole is substantially “t” shaped when viewed normal to the base.

7. The anchor clip assembly of claim 1, wherein the panel further comprises a body, and wherein the fixing clip and the anchor clip are both oriented substantially normal to the body.

8. The anchor clip assembly of claim 1, wherein the elongated hole comprises a wide portion and a narrow portion, wherein a width of the narrow portion is approximately equal to a width of the aperture.

9. The anchor clip assembly of claim 1, wherein a length of a lower portion of the fixing clip is greater than a length of an upper portion of the fixing clip, and wherein the length of the lower portion of the fixing clip is approximately equal to a length of the aperture.

10. A method of detaching a panel from a base, the panel comprising a fixing clip and an anchor clip, the base comprising an aperture and an elongated hole, the elongated hole comprising a narrow portion and a wide portion, wherein the fixing clip is engaged with the aperture, and wherein the anchor clip is engaged with the elongated hole, the method comprising:
disengaging the fixing clip from the aperture;
sliding the anchor clip along a longitudinal direction of the elongated hole;
positioning the anchor clip at the wide portion of the elongated hole; and
pulling the anchor clip through the wide portion of the elongated hole.

11. The method of claim 10, wherein disengaging the fixing clip from the aperture comprises pulling the fixing clip through the aperture in a direction normal to the base.

12. The method of claim 10, wherein the anchor clip comprises a plurality of angled portions, wherein each of the angled portions includes a leg, and wherein the method further comprises positioning the leg at the wide portion of the elongated hole.

13. A panel, comprising:
a fixing clip formed on the panel and configured to engage with an aperture in a base; and
an anchor clip formed on the panel and configured to be slidably engaged with an elongated hole in the base, wherein a height of the anchor clip is greater than a height of the fixing clip.

14. The panel of claim 13, wherein the panel further comprises a body portion, and wherein the fixing clip and the anchor clip are both oriented substantially normal to the body portion.

15. The panel of claim 13, wherein the panel comprises a plurality of fixing clips, and wherein a single anchor clip is formed on the panel.

16. The panel of claim 13, wherein the fixing clip comprises a metal clip, wherein the anchor clip is integrally formed with the panel, and wherein the anchor clip is made from the same material as the panel.

17. The panel of claim 16, wherein the fixing clip comprises a tower integrally formed with the panel, and wherein the metal clip is coupled to the tower.

18. The panel of claim 13, wherein the anchor clip comprises a plurality of angled portions, wherein each one of the angled portions includes a leg disposed on an inside edge of a free end of the angled portion, and wherein the angled portions are configured to deform in response to an applied force.

19. The panel of claim 18, wherein the leg extends downwardly from the free end of the angled portion, and wherein the leg is configured to engage with a narrow portion of the elongated hole.

20. The panel of claim 13, wherein a length of a lower portion of the fixing clip is greater than a length of an upper portion of the fixing clip, and wherein the length of the lower portion of the fixing clip is approximately equal to a length of the aperture.
